(19) United States
(12) Patent Application Publication
(10) Pub. No.: US 2007/0236868 A1
(43) Pub. Date: Oct. 11, 2007

(54) AUDIO REPRODUCTION DEVICE ASSEMBLY ADAPTED FOR USE WITH A PORTABLE RECHARGABLE AUDIO PLAYBACK DEVICE

(75) Inventor: Duan-Cheng HSIEH, Taipei City (TW)

Correspondence Address: MCNEES WALLACE & NURICK LLC, 100 PINE STREET, P.O. BOX 1166, HARRISBURG, PA, 17108-1166, US

(73) Assignee: HABITEX CORPORATION, Taipei City (TW)

(21) Appl. No.: 11/277,820

(22) Filed: Mar. 29, 2006

(51) Int. Cl. H02B 1/00

(52) U.S. Cl. 361/600

(57) ABSTRACT

An audio reproduction device assembly includes a housing unit housed with a lighting unit, a loudspeaker unit and a circuit unit. The circuit unit includes a control circuit connected electrically to an external power source, the lighting unit and the loudspeaker unit so as to control activation thereof in response to operation of an operating unit mounted on the housing unit. When a portable rechargeable audio playback device is coupled electrically to the audio reproduction device assembly via a transmission port, the control circuit receives audio signals from the audio playback device via the transmission port, enables the loudspeaker unit to reproduce the audio signals, and enables a charging circuit to charge the audio playback device via the transmission port.

### BACKGROUND OF THE INVENTION

1. Field of the Invention

The invention relates to an audio reproduction device assembly, more particularly to an audio reproduction device assembly adapted for use with a portable rechargeable audio playback device.

2. Description of the Related Art

FIG. 1 illustrates a conventional audio reproduction device 2 for use with a portable audio playback device 1, such as an ipod® player. The conventional audio reproduction device 2 includes a base 21 configured with a receiving groove for receiving the audio playback device 1, two loudspeakers 22 mounted respectively on opposite lateral sides of the base 21, a control unit 23 mounted in the base 21 and connected electrically to the loudspeakers 22, a transmission port 231 mounted in the base 21 and connected electrically to the control unit 23 and the audio playback device 1, and an operating unit 24 mounted on the base 21, connected electrically to the control unit 23 and including a plurality of control keys 241. The control unit 23 is capable of controlling the loudspeakers 22 in response to operation of the operating unit 24. As such, when the audio playback device 1 is coupled electrically to the transmission port 231, the control unit 23 receives audio signals from the audio playback device 1 via the transmission port 231, and enables the loudspeakers 22 to reproduce the audio signals.

However, the conventional audio production device 2 having only audio reproduction function cannot satisfy requirement for expanded functionality.

### SUMMARY OF THE INVENTION

Therefore, the object of the present invention is to provide an audio reproduction device assembly that can provide illumination function, and audio reproduction and charging functions when used with a portable rechargeable audio playback device.

According to the present invention, there is provided an audio reproduction device assembly adapted for use with a portable rechargeable audio playback device. The audio reproduction device assembly comprises:

a housing unit;

a lighting unit disposed in the housing unit;

a loudspeaker unit disposed in the housing unit;

a circuit unit disposed in the housing unit and including
a control circuit connected electrically to the lighting unit and the loudspeaker unit so as to control activation thereof and adapted to be connected electrically to an external power source, and
a charging circuit connected electrically to the control circuit;

a transmission port mounted on the housing unit, connected electrically to the circuit unit, and adapted to be coupled electrically to the audio playback device; and

an operating unit mounted on the housing unit and connected electrically to the control circuit of the circuit unit, the operating unit being operable so as to enable the control circuit of the circuit unit to activate the lighting unit and the loudspeaker unit.

When the audio playback device is coupled electrically to the transmission port, the control circuit of the circuit unit is adapted to receive audio signals from the audio playback device via the transmission port, enables the loudspeaker unit to reproduce the audio signals, and enables the charging circuit to charge the audio playback device via the transmission port.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view of a conventional audio reproduction device for use with a portable audio playback device;

FIG. 2 is a perspective view showing the preferred embodiment of an audio reproduction device assembly according to the present invention when used with a portable rechargeable audio playback device;

FIG. 3 is an exploded perspective view of the preferred embodiment;

FIG. 4 is a schematic circuit block diagram of the preferred embodiment;

FIG. 5 is a perspective view showing the preferred embodiment in a state of use; and

FIG. 6 is a perspective view showing the preferred embodiment in another state of use.

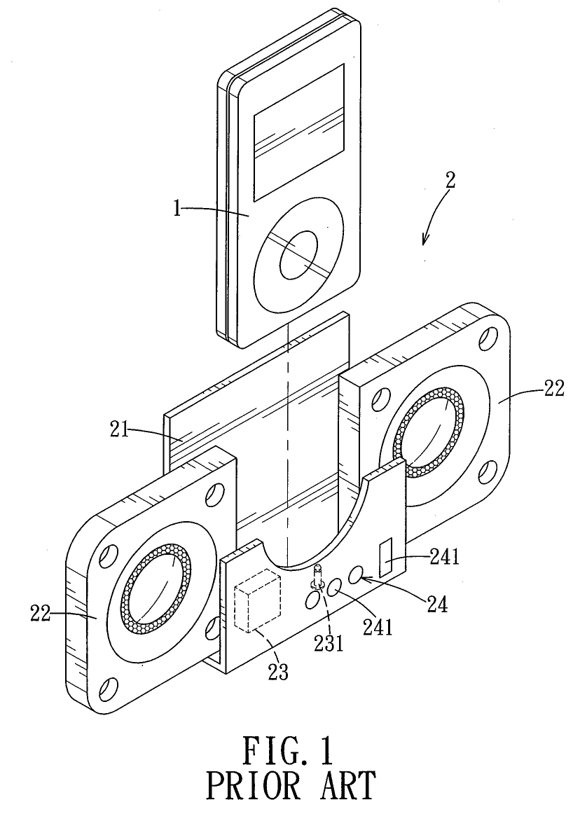

### DETAILED DESCRIPTION OF THE PREFERRED EMBODIMENT

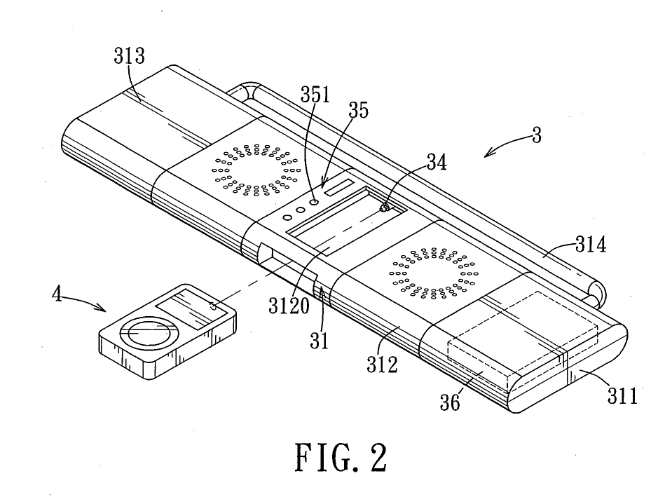

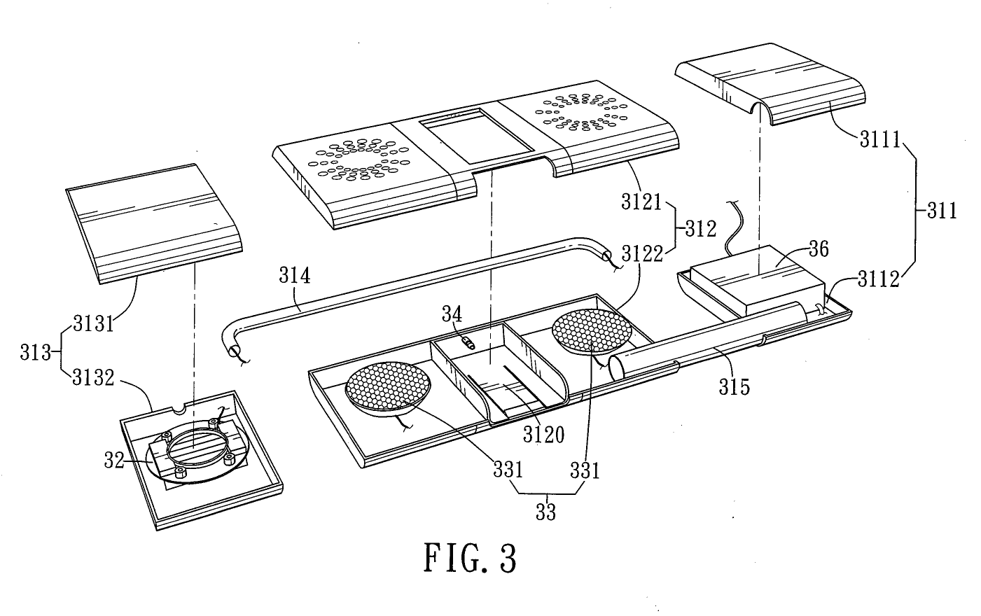

Referring to FIGS. 2 to 4, the preferred embodiment of an audio reproduction device assembly 3 according to the present invention is shown to be adapted for use with a portable rechargeable audio playback device 4, such as an ipod® player. The audio reproduction device assembly 3 includes a housing unit 31, a lighting unit 32, a loudspeaker unit 33, a circuit unit 36, a transmission port 34, and an operating unit 35.

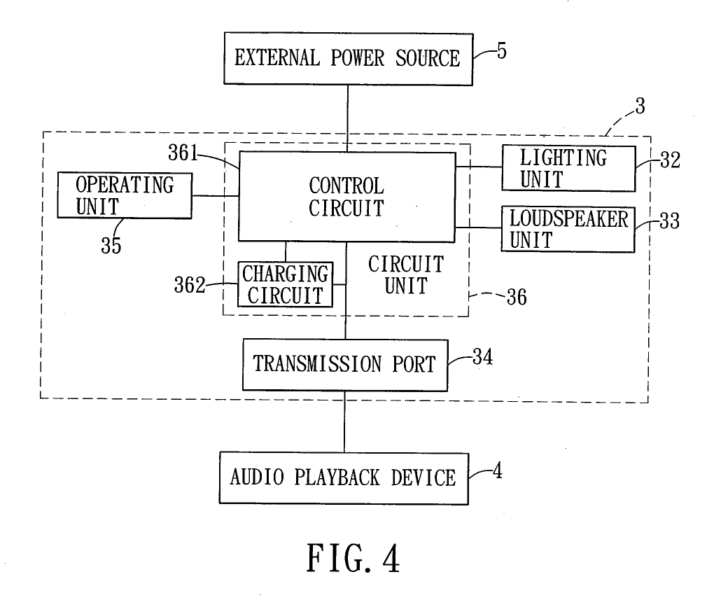

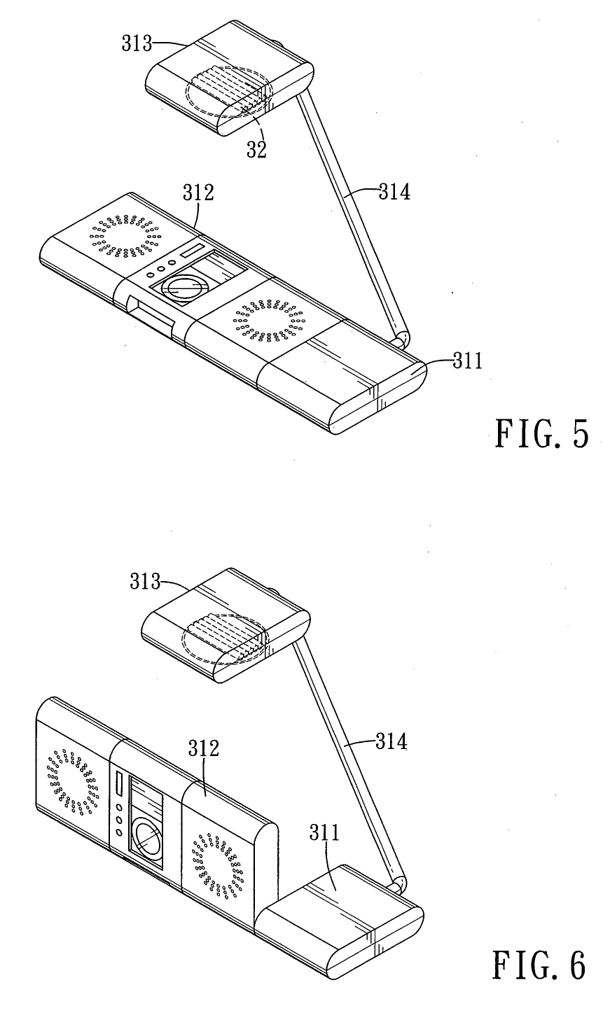

In this embodiment, the housing unit 31 includes a first housing 311, a second housing 312, a third housing 313, and a support member 314, as shown in FIG. 2. In this embodiment, as shown in FIG. 4, the first housing 311 consists of two complementary housing parts 3111, 3112. The second housing 312 is disposed adjacent to the first housing 311, and is connected pivotally to the first housing 311 via a pivot rod 315 such that the second housing 312 is rotatable relative to the first housing 311, as shown in FIG. 6. In this embodiment, the second housing 312 is configured with a receiving groove 3120 adapted for receiving the audio playback device 4, consists of two complementary housing parts 3121, 3122, and serves as a loudspeaker housing. The third housing 313 is spaced apart from the first housing 311. In this embodiment, the third housing 313 serves as a shade member, and consists of two complementary housing parts 3131, 3132. The support member 314 interconnects pivotally the first and third housings 311, 313, and is rotatable relative to the first housing 311 such that the third housing 313 supported by the support member 314 is movable relative to the first housing 311, as shown in FIG. 5.

In this embodiment, the lighting unit 32 is disposed in the third housing 313 of the housing unit 31.

In this embodiment, the loudspeaker unit 33 includes a pair of loudspeakers 331 that are disposed in the second housing 312 of the housing unit 31.

In this embodiment, the circuit unit 36 is disposed in the first housing 311 of the housing unit 31, and includes a control circuit 361 and a charging circuit 362. The control circuit 361 is connected electrically to the lighting unit 32 and the loudspeaker unit 33 so as to control activation thereof, and is adapted to be connected electrically to an external power source 5, as shown in FIG. 4. The charging circuit 362 is connected electrically to the control circuit 361.

The transmission port 34 is connected electrically to the control circuit 361 and the charging circuit 362 of the circuit unit 36, and is adapted to be coupled electrically to the audio playback device 4. In this embodiment, the transmission port 34 is mounted on the second housing 312 of the housing unit 31, and is disposed in the receiving groove 3120.

The operating unit 35 is connected electrically to the control circuit 361 of the circuit unit 36. In this embodiment, the operating unit 35 is mounted on the second housing 312 of the housing unit 31, and includes a plurality of control keys 351. The operating unit 35 is operable so as to enable the control circuit 361 of the circuit unit 36 to activate the lighting unit 32 and the loudspeaker unit 33.

When the audio playback device 4 is coupled electrically to the transmission port 34, the control circuit 361 of the circuit unit 36 is adapted to receive audio signals from the audio playback device 4 via the transmission port 34, enables the loudspeaker unit 33 to reproduce the audio signals, and enables the charging circuit 362 to charge the audio playback device 4 via the transmission port 34.

In sum, the audio reproduction device assembly 3 of the present invention is integrated with illumination, charging and audio reproduction functions, thereby resulting in convenience during use. Moreover, the housing unit 1 is operable between a retracted position, as shown in FIG. 2, and a desired position, as shown in FIGS. 5 and 6. When the housing unit 1 is in the retracted position, the audio reproduction device assembly 3 of the present invention has a compact size as compared to the aforesaid conventional audio reproduction device such that carrying the same can be facilitated.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. An audio reproduction device assembly adapted for use with a portable rechargeable audio playback device, comprising:
a housing unit;
a lighting unit disposed in said housing unit;
a loudspeaker unit disposed in said housing unit;
a circuit unit disposed in said housing unit and including
a control circuit connected electrically to said lighting unit and said loudspeaker unit so as to control activation thereof and adapted to be connected electrically to an external power source, and
a charging circuit connected electrically to said control circuit;
a transmission port mounted on said housing unit, connected electrically to said circuit unit, and adapted to be coupled electrically to the audio playback device; and
an operating unit mounted on said housing unit and connected electrically to said control circuit of said circuit unit, said operating unit being operable so as to enable said control circuit of said circuit unit to activate said lighting unit and said loudspeaker unit;
wherein, when the audio playback device is coupled electrically to said transmission port, said control circuit of said circuit unit is adapted to receive audio signals from the audio playback device via said transmission port, enables said loudspeaker unit to reproduce the audio signals, and enables said charging circuit to charge the audio playback device via said transmission port.

2. The audio reproduction device assembly as claimed in claim 1, wherein said housing unit includes:
a first housing housed with said circuit unit;
a second housing housed with said loudspeaker unit, and connected pivotally to and disposed adjacent to said first housing such that said second housing is rotatable relative to said first housing;
a third housing housed with said lighting unit and spaced apart from said first housing; and
a support member interconnecting pivotally said first and third housings and rotatable relative to said first housing such that said third housing supported by said support member is movable relative to said first housing.

3. The audio reproduction device assembly as claimed in claim 2, wherein said second housing of said housing unit is configured with a receiving groove adapted for receiving the audio playback device, and is mounted with said transmission port, said transmission port being disposed in said receiving groove.
